(19) United States
(12) Patent Application Publication
(10) Pub. No.: US 2026/0332181 A1
(43) Pub. Date: Oct. 22, 2026

(54) Electronic device and its multi-input amplifier circuit

(71) Applicant: REALTEK SEMICONDUCTOR CORPORATION, HSINCHU (TW)

(72) Inventors: CHUN-PIN CHIEN, HSINCHU (TW); HUNG-YUAN YANG, HSINCHU (TW)

(21) Appl. No.: 19/630,988

(22) Filed: Mar. 27, 2026

(30) Foreign Application Priority Data
Apr. 17, 2025 (TW) 114114605

(51) Int. Cl. H04B 1/40; H04L 25/02

(52) U.S. Cl. CPC H04B 1/40; H04L 25/02

(57) ABSTRACT

An electronic device includes a first baseband circuit, a second baseband circuit, a first transceiver circuit, a second transceiver circuit, and a switch. The first transceiver circuit is coupled to the first baseband circuit and includes a first transmission circuit and a multi-input amplifier circuit. The first transmission circuit is coupled to the first baseband circuit. The multi-input amplifier circuit is coupled to the first transmission circuit. The second transceiver circuit is coupled to the second baseband circuit and includes a second transmission circuit and a driver amplifier. The second transmission circuit is coupled to the second baseband circuit. The switch is coupled to the second transmission circuit, the multi-input amplifier circuit, and the driver amplifier. The switch is controlled by the first baseband circuit or the second baseband circuit to connect the second transmission circuit to the multi-input amplifier circuit or the driver amplifier.

### BACKGROUND OF THE INVENTION

### 1. Field of the Invention

The present invention generally relates to an amplifier circuit, and more particularly, to a multi-input amplifier circuit.

### 2. Description of Related Art

Reference is made to FIG. 1, which is a functional block diagram of a conventional electronic device according to an embodiment. The electronic device 100 includes a baseband circuit 111, a baseband circuit 121, a transceiver circuit 110, a transceiver circuit 120, a switch SW1, a switch SW2, an antenna 119, and an antenna 129. The baseband circuit 111 receives and transmits signals through the transceiver circuit 110 and the antenna 119. The baseband circuit 121 receives and transmits signals through the transceiver circuit 120 and the antenna 129. The switch SW1 switches the antenna 119 to the transmission circuit 113 or the receiving circuit 117. The switch SW2 switches the antenna 129 to the transmission circuit 123 or the receiving circuit 127. The switch SW1 and the switch SW2 can be controlled respectively by the baseband circuit 111 and the baseband circuit 121.

The transceiver circuit 110 includes a digital-to-analog converter (DAC) 112, a transmission circuit 113, a driver amplifier 114, a power amplifier (PA) 115, a low noise amplifier (LNA) 116, a receiving circuit 117, and an analog-to-digital converter (ADC) 118.

The transceiver circuit 120 includes a DAC 122, a transmission circuit 123, a driver amplifier 124, a PA 125, an LNA 126, a receiving circuit 127, and an ADC 128.

Because the electronic device 100 includes two transceiver circuits, the electronic device 100 can simultaneously transmit two independent signals with different frequencies. Therefore, the electronic device 100 has a larger transmission bandwidth. However, because the PA 115 and the PA 125 consume considerable power, using two transceiver circuits simultaneously to transmit signals increases the total power consumption of the electronic device 100.

### SUMMARY OF THE INVENTION

In view of the issues of the prior art, an object of the present invention is to provide an electronic device and a multi-input amplifier circuit, so as to make an improvement to the prior art.

According to one aspect of the present invention, an electronic device is provided. The electronic device includes a first baseband circuit, a second baseband circuit, a first transceiver circuit, a second transceiver circuit, and a switch. The first transceiver circuit is coupled to the first baseband circuit and includes a first transmission circuit and a multi-input amplifier circuit. The first transmission circuit is coupled to the first baseband circuit. The multi-input amplifier circuit is coupled to the first transmission circuit. The second transceiver circuit is coupled to the second baseband circuit and includes a second transmission circuit and a driver amplifier. The second transmission circuit is coupled to the second baseband circuit. The switch is coupled to the second transmission circuit, the multi-input amplifier circuit, and the driver amplifier. The switch is controlled by the first baseband circuit or the second baseband circuit and is configured to connect the second transmission circuit to the multi-input amplifier circuit or the driver amplifier.

According to another aspect of the present invention, a multi-input amplifier circuit is provided. The multi-input amplifier circuit has a first input terminal, a second input terminal, and a first output terminal. The first input terminal is configured to receive a first signal, and the second input terminal is configured to receive a second signal. The multi-input amplifier circuit includes a power divider, a first switch, a second switch, a third switch, an amplifier, and a power combiner. The power divider has a third input terminal, a second output terminal, and a third output terminal, and is configured to generate a first intermediate signal and a second intermediate signal according to the first signal. The first switch is coupled to the first input terminal and the third input terminal. The second switch is coupled to the second output terminal and the first switch. The third switch is coupled to the second input terminal and the third output terminal. The amplifier is coupled to the second switch and the third switch and is configured to amplify the first intermediate signal or the first signal to generate a third signal, and to amplify the second intermediate signal or the second signal to generate a fourth signal. The power combiner is coupled to the amplifier and the first output terminal and is configured to combine the third signal and the fourth signal to generate a fifth signal.

According to still another aspect of the present invention, a multi-input amplifier circuit is provided. The multi-input amplifier circuit has a first input terminal, a second input terminal, and an output terminal. The first input terminal is configured to receive a first signal, and the second input terminal is configured to receive a second signal. The multi-input amplifier circuit includes a power divider, a first switch, a second switch, an amplifier, and a power combiner. The power divider includes a first primary coil, a first secondary coil, a second primary coil, and a second secondary coil and is configured to generate a first intermediate signal and a second intermediate signal. The first primary coil is coupled to the first input terminal, and the second primary coil is coupled to a reference voltage. The first switch is coupled to the first primary coil and the second primary coil. The second switch is coupled to the second input terminal and the second primary coil. The amplifier is coupled to the first secondary coil and the second secondary coil and is configured to amplify the first intermediate signal and the second intermediate signal to respectively generate a third signal and a fourth signal. The power combiner is coupled to the amplifier and the output terminal and is configured to combine the third signal and the fourth signal to generate a fifth signal.

According to still another aspect of the present invention, a multi-input amplifier circuit is provided. The multi-input amplifier circuit has a first input terminal, a second input terminal, and an output terminal. The first input terminal is configured to receive a first signal, and the second input terminal is configured to receive a second signal. The multi-input amplifier circuit includes a power divider, an amplifier, and a power combiner. The power divider is coupled to the first input terminal and the second input terminal, is configured to generate a first intermediate signal and a second intermediate signal, and includes a first coupler, a second coupler, and a third coupler that are mutually coupled. The amplifier is coupled to the power divider and is configured to amplify the first intermediate signal and the second intermediate signal to respectively generate a third signal and a fourth signal. The power combiner is coupled to the amplifier and the output terminal and is configured to combine the third signal and the fourth signal to generate a fifth signal.

The technical means embodied in the embodiments of the present invention can solve at least one of the problems of the prior art. Therefore, compared to the prior art, the present invention can reduce power consumption.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of a conventional electronic device according to an embodiment.

FIGS. 2A-2B are functional block diagrams of the electronic device according to an embodiment of the present invention.

FIGS. 3A-3B are circuit diagrams of a multi-input amplifier circuit according to an embodiment of the present invention.

FIGS. 4A-4B are the circuit diagrams of a multi-input amplifier circuit according to an embodiment of the present invention.

FIGS. 5A-5B are circuit diagrams of a multi-input amplifier circuit according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and its multi-input amplifier circuit. On account of that some or all elements of the electronic device and its multi-input amplifier circuit could be known, the detail of such elements is omitted provided that such detail has little to do with the features of this disclosure, and that this omission nowhere dissatisfies the specification and enablement requirements.

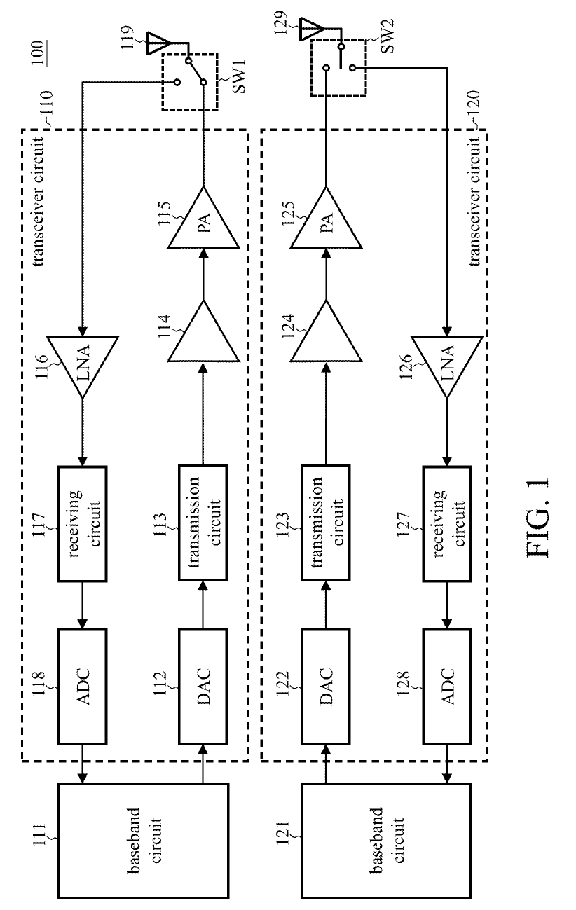

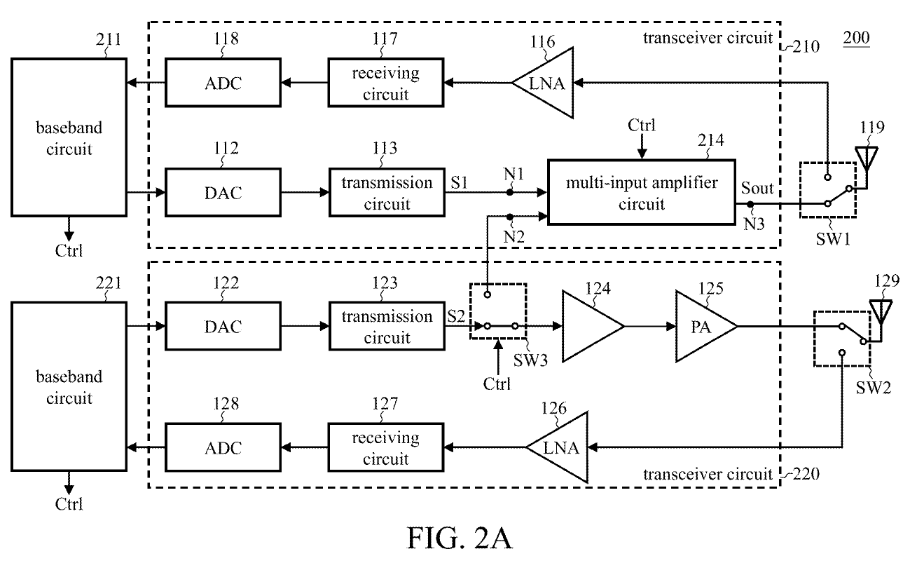

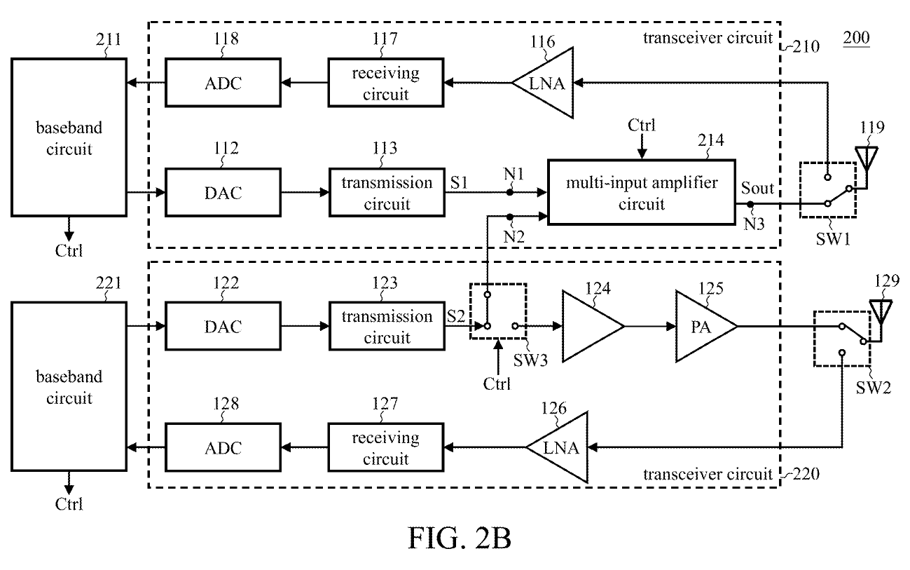

Reference is made to FIGS. 2A and 2B, which are the functional block diagrams of an electronic device according to an embodiment of the present invention. The electronic device 200 includes a baseband circuit 211, a baseband circuit 221, a transceiver circuit 210, a transceiver circuit 220, a switch SW1, a switch SW2, an antenna 119, and an antenna 129. In FIGS. 1 and 2A-2B, components denoted by the same reference numeral have similar or identical functions. The switch SW1 and the switch SW2 can be controlled respectively by the baseband circuit 211 and the baseband circuit 221.

The transceiver circuit 210 includes a multi-input amplifier circuit 214. The multi-input amplifier circuit 214 is coupled between the transmission circuit 113 and the antenna 119, and is coupled to the transmission circuit 123 through a switch SW3. The multi-input amplifier circuit 214 is a multi-input single-output circuit. The input terminal N1 of the multi-input amplifier circuit 214 is coupled or electrically connected to the transmission circuit 113 to receive the signal S1; the input terminal N2 of the multi-input amplifier circuit 214 is coupled or electrically connected to the switch SW3; the output terminal N3 of the multi-input amplifier circuit 214 is coupled or electrically connected to the switch SW1. The multi-input amplifier circuit 214 amplifies the signal S1 (FIG. 2A) or amplifies the signal S1 and the signal S2 at substantially the same time (FIG. 2B) to generate an amplified signal Sout.

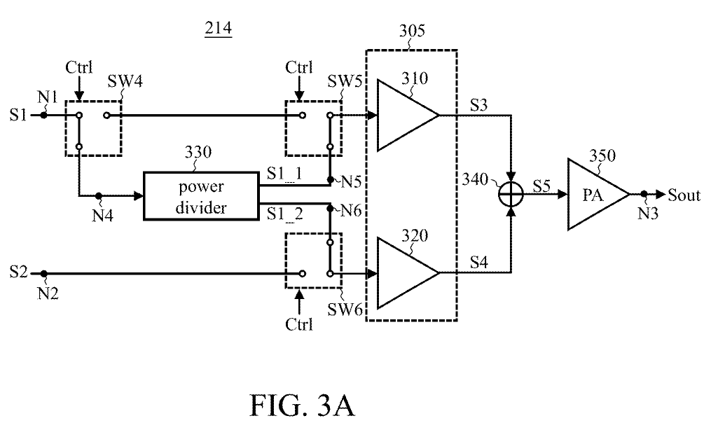

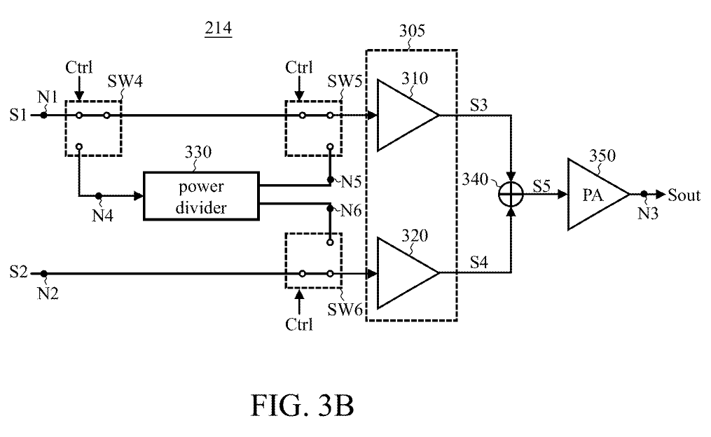

The details of the multi-input amplifier circuit 214 will be discussed in detail below in connection with FIGS. 3A-3B, 4A-4B and 5A-5B.

The transceiver circuit 220 is similar to the transceiver circuit 120, except that the transceiver circuit 220 further includes the switch SW3. The switch SW3, which is a single-pole double-throw switch, can switch between the first path (between the transmission circuit 123 and the driver amplifier 124) and the second path (between the transmission circuit 123 and the multi-input amplifier circuit 214). The switch SW3 is controlled by the baseband circuit 211 or the baseband circuit 221 through the control signal Ctrl.

When the switch SW3 switches to the first path (i.e., the transmission circuit 123 is electrically connected to the driver amplifier 124, and the transmission circuit 123 is not electrically connected to the multi-input amplifier circuit 214, as shown in FIG. 2A), the electronic device 200 can simultaneously use two amplifiers (124 and 214) to amplify the signal S1 and the signal S2, respectively. The signal S1 and the signal S2 are respectively transmitted through the antenna 119 and the antenna 129. The frequency band of the signal S1 and the frequency band of the signal S2 are different or do not overlap.

When the switch SW3 switches to the second path (i.e., the transmission circuit 123 is electrically connected to the multi-input amplifier circuit 214, and the transmission circuit 123 is not electrically connected to the driver amplifier 124, as shown in FIG. 2B), the electronic device 200 uses the multi-input amplifier circuit 214 to simultaneously amplify the signal S1 and the signal S2. The signal S1 and the signal S2 are transmitted through the antenna 119. The frequency band of the signal S1 and the frequency band of the signal S2 are different or do not overlap.

Compared to the application scenario of FIG. 2A, the application scenario of FIG. 2B is more power-saving, because the driver amplifier 124 and the PA 125 can be turned off. In some cases, when the quality requirement of a signal is relatively low, the power of the signal is relatively low, and/or the modulation scheme of the signal is relatively simple, the electronic device 200 can operate in the application scenario of FIG. 2B to save power.

The electronic device 200 is a multi-input multi-carrier circuit. In some embodiments, the electronic device 200 is part of a wireless transceiver and can be applied to signals such as Wi-Fi or Long Term Evolution (LTE) (e.g., 4G, 5G).

In some embodiments, if the gain of the driver amplifier 124 is large enough, then the PA 125 can be omitted.

Reference is made to FIGS. 3A-3B, which are the circuit diagrams of the multi-input amplifier circuit 214 according to an embodiment of the present invention. The operation scenarios of FIGS. 3A and 3B correspond to FIGS. 2A and 2B, respectively.

The multi-input amplifier circuit 214 includes an amplifier 305, a power divider 330, a power combiner 340, a PA 350, a switch SW4, a switch SW5, and a switch SW6. The power divider 330 has an input terminal N4, an output terminal N5, and an output terminal N6. The amplifier 305 includes a driver amplifier 310 and a driver amplifier 320. The switch SW4, the switch SW5, and the switch SW6 are all single-pole double-throw switches, and all controlled by the baseband circuit 211 or the baseband circuit 221.

The first terminal of the switch SW4 is coupled or electrically connected to the input terminal N1 (to receive the signal S1); the second terminal of the switch SW4 is coupled or electrically connected to the input terminal N4 of the power divider 330; the third terminal of the switch SW4 is coupled or electrically connected to the driver amplifier 310 through the switch SW5.

The first terminal of the switch SW5 is coupled or electrically connected to the input terminal N1 through the switch SW4 (to receive the signal S1); the second terminal of the switch SW5 is coupled or electrically connected to the output terminal N5 of the power divider 330; the third terminal of the switch SW5 is coupled or electrically connected to the driver amplifier 310.

The first terminal of the switch SW6 is coupled or electrically connected to the input terminal N2 (to receive the signal S2); the second terminal of the switch SW6 is coupled or electrically connected to the output terminal N6 of the power divider 330; the third terminal of the switch SW6 is coupled or electrically connected to the driver amplifier 320.

In the operation scenario of FIG. 3A, the power divider 330 generates the intermediate signal S1_1 and the intermediate signal S1_2 based on the signal S1. The sum of the power of the intermediate signal S1_1 and the power of the intermediate signal S1_2 substantially equal the power of the signal S1. In some embodiments, the power of the intermediate signal S1_1 and the power of the intermediate signal S1_2 may be 1:1. The operating principle of the power divider 330 is well known to people having ordinary skill in the art, so further elaboration is omitted for brevity.

The driver amplifier 310 amplifies the intermediate signal S1_1 to generate the signal S3. The output terminal of the driver amplifier 310 is coupled or electrically connected to the power combiner 340.

The driver amplifier 320 amplifies the intermediate signal S1_2 to generate the signal S4. The output terminal of the driver amplifier 320 is coupled or electrically connected to the power combiner 340.

The power combiner 340 is coupled or electrically connected to the driver amplifier 310, the driver amplifier 320, and the PA 350. The power combiner 340 combines the signal S3 and the signal S4 to generate the signal S5. In other words, the power of the signal S5 substantially equals the sum of the power of the signal S3 and the power of the signal S4.

The PA 350 amplifies the signal S5 to generate the amplified signal Sout.

In some embodiments, if the gain of the driver amplifier 310 and the driver amplifier 320 is sufficiently large, then the PA 350 can be omitted. In this case, the amplified signal Sout equals the signal S5.

In the operation scenario of FIG. 3A, the switch SW4 connects the input terminal N1 to the input terminal N4 of the power divider 330, so that the power divider 330 receives the signal S1. The output terminal N5 and the output terminal N6 of the power divider 330 are respectively connected to the driver amplifier 310 and the driver amplifier 320. Therefore, the driver amplifier 310 and the driver amplifier 320 respectively amplify the intermediate signal S1_1 and the intermediate signal S1_2. In other words, the signal S5 is equivalent to the result of the signal S1 being amplified by the amplifier 305.

Reference is made to FIG. 3B. In the operation scenario of FIG. 3B, the switch SW4 and the switch SW5 connect the input terminal of the driver amplifier 310 to the input terminal N1, while the switch SW6 connects the input terminal of the driver amplifier 320 to the input terminal N2. Therefore, the power divider 330 is inactive, and the driver amplifier 310 and the driver amplifier 320 respectively amplify the signal S1 and the signal S2 to generate the signal S3 and the signal S4, respectively. In other words, the signal S5 is a combination of the signal S1 after amplification (substantially the signal S3) and the signal S2 after amplification (substantially the signal S4).

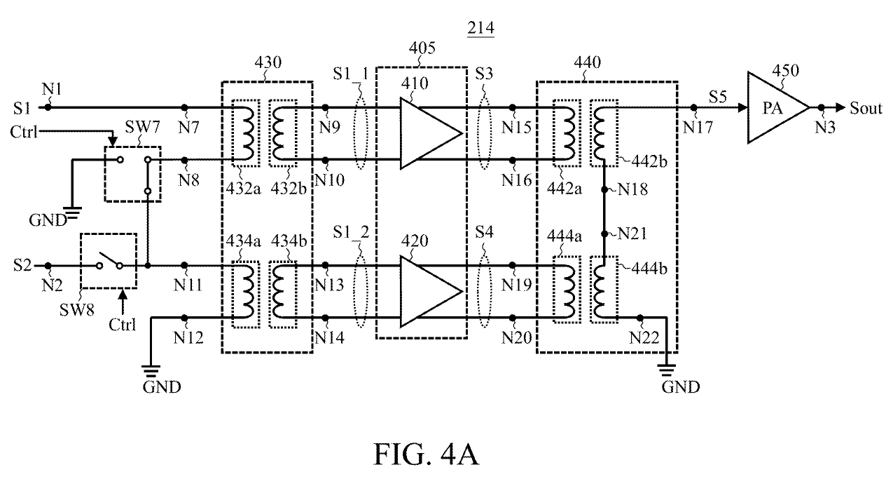

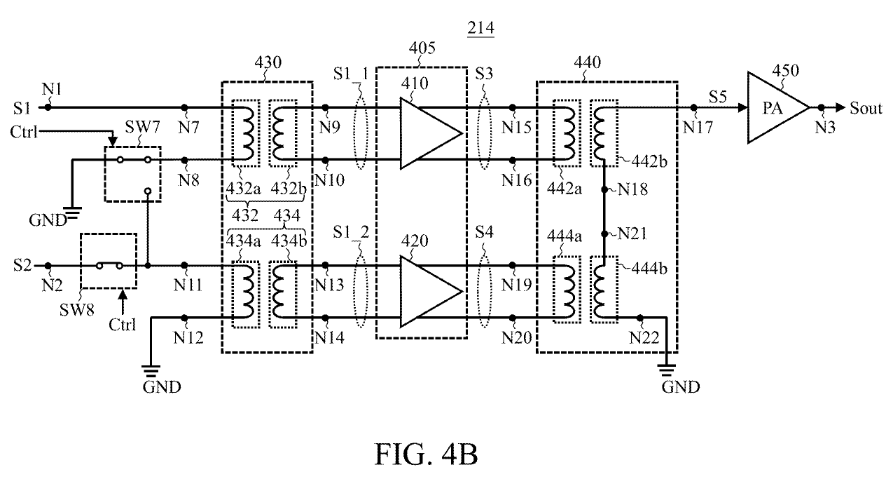

Reference is made to FIGS. 4A-4B, which are circuit diagrams of the multi-input amplifier circuit 214 according to another embodiment of the present invention. The operation scenarios of FIGS. 4A and 4B correspond to FIGS. 2A and 2B, respectively.

The multi-input amplifier circuit 214 includes an amplifier 405, a power divider 430, a power combiner 440, a PA 450, a switch SW7, and a switch SW8. The amplifier 405 contains a driver amplifier 410 and a driver amplifier 420. The switch SW7 is a single-pole double-throw switch. The switch SW7 and the switch SW8 are both controlled by the baseband circuit 211 or the baseband circuit 221.

The power divider 430 includes a first primary coil 432a, a first secondary coil 432b, a second primary coil 434a, and a second secondary coil 434b.

One terminal N7 of the first primary coil 432a is coupled or electrically connected to the input terminal N1 (to receive the signal S1); the other terminal N8 of the first primary coil 432a is coupled or electrically connected to the switch SW7. The terminal N7 and the terminal N8 constitute the first input port of the power divider 430.

The two terminals of the first secondary coil 432b (N9 and N10, constituting the first output port of the power divider 430) are coupled or electrically connected to the driver amplifier 410.

One terminal N11 of the second primary coil 434a is coupled or electrically connected to the switch SW8; the other terminal N12 of the second primary coil 434a is coupled or electrically connected to the reference voltage GND. The terminal N11 and the terminal N12 constitute the second input port of the power divider 430.

The two terminals of the second secondary coil 434b (N13 and N14, constituting the second output port of the power divider 430) are coupled or electrically connected to the driver amplifier 420.

The power combiner 440 is a multi-tap transformer. The power combiner 440 includes a first primary coil 442a, a first secondary coil 442b, a second primary coil 444a, and a second secondary coil 444b.

The two terminals of the first primary coil 442a (N15 and N16, constituting the first input port of the power combiner 440) are coupled or electrically connected to the output terminal of the driver amplifier 410 to receive the signal S3.

One terminal N17 of the first secondary coil 442b (i.e., one output terminal of the power combiner 440) is coupled or electrically connected to the PA 450; the other terminal N18 of the first secondary coil 442b is coupled or electrically connected to a terminal N21 of the second secondary coil 444b.

The two terminals of the second primary coil 444a (N19 and N20, constituting the second input port of the power combiner 440) are coupled or electrically connected to the output terminal of the driver amplifier 420 to receive the signal S4.

The other terminal N22 of the second secondary coil 444b is coupled or electrically connected to the reference voltage GND.

The terminal N17 and the terminal N22 constitute the output port of the power combiner 440.

The first terminal of the switch SW7 is coupled or electrically connected to the reference voltage GND (e.g., ground); the second terminal of the switch SW7 is coupled or electrically connected to the terminal N8 of the first primary coil 432a; the third terminal of the switch SW7 is coupled or electrically connected to the terminal N11 of the second primary coil 434a.

One terminal of the switch SW8 is coupled or electrically connected to the input terminal N2 to receive the signal S2; another terminal of the switch SW8 is coupled or electrically connected to the switch SW7 and the terminal N11 of the second primary coil 434a.

The first output port of the power divider 430 outputs the intermediate signal S1_1, and is coupled or electrically connected to the driver amplifier 410; the second output port of the power divider 430 outputs the intermediate signal S1_2, and is coupled or electrically connected to the driver amplifier 420.

The power combiner 440 combines the signal S3 and the signal S4 to generate the signal S5. In other words, the power of the signal S5 substantially equals the sum of the power of the signal S3 and the power of the signal S4.

The PA 450 is coupled or electrically connected to the power combiner 440 and is configured to amplify the signal S5 to generate the amplified signal Sout.

In some embodiments, if the gains of the driver amplifier 410 and the driver amplifier 420 are large enough, then the PA 450 can be omitted. In this case, the amplified signal Sout equals the signal S5.

In the operation scenario of FIG. 4A, the switch SW7 connects the terminal N8 of the first primary coil 432a to the terminal N11 of the second primary coil 434a, and the switch SW8 does not connect the terminal N11 of the second primary coil 434a to the input terminal N2. Therefore, the power divider 430 generates the intermediate signal S1_1 and the intermediate signal S1_2 according to the signal S1. In some embodiments, the power of the intermediate signal S1_1 and the power of the intermediate signal S1_2 may be 1:1. As shown in FIG. 4A, when the first primary coil 432a and the second primary coil 434a are connected in series through the switch SW7, the power divider 430 forms a multi-tap transformer. The operating principle of the power divider 430 is well known to people having ordinary skill in the art, so further elaboration is omitted for brevity.

Reference is made to FIG. 4B. In the operation scenario of FIG. 4B, the switch SW7 connects the terminal N8 of the first primary coil 432a to the reference voltage GND (rather than the terminal N11 of the second primary coil 434a), and the switch SW8 is turned on to connect a terminal N11 of the second primary coil 434a to the input terminal N2. Therefore, the first primary coil 432a and the second primary coil 434a are not connected in series, and the power divider 430 substantially includes two transformers: the transformer 432 (composed of the first primary coil 432a and the first secondary coil 432b) and the transformer 434 (composed of the second primary coil 434a and the second secondary coil 434b). In this way, the intermediate signal S1_1 is substantially equal to the signal S1, and the intermediate signal S1_2 is substantially equal to the signal S2. In other words, the signal S5 is a combination of the signal S1 after amplification (substantially the signal S3) and the signal S2 after amplification (substantially the signal S4).

Adjusting the turns ratio of the coils to achieve power and/or voltage adjustment for signal coupling is well known to people having ordinary skill in the art, so further elaboration is omitted for brevity.

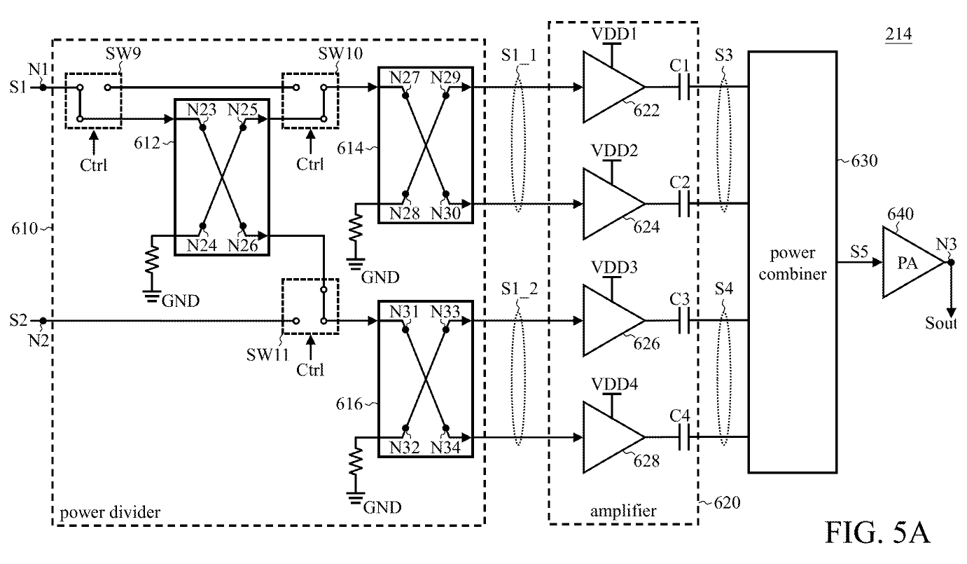

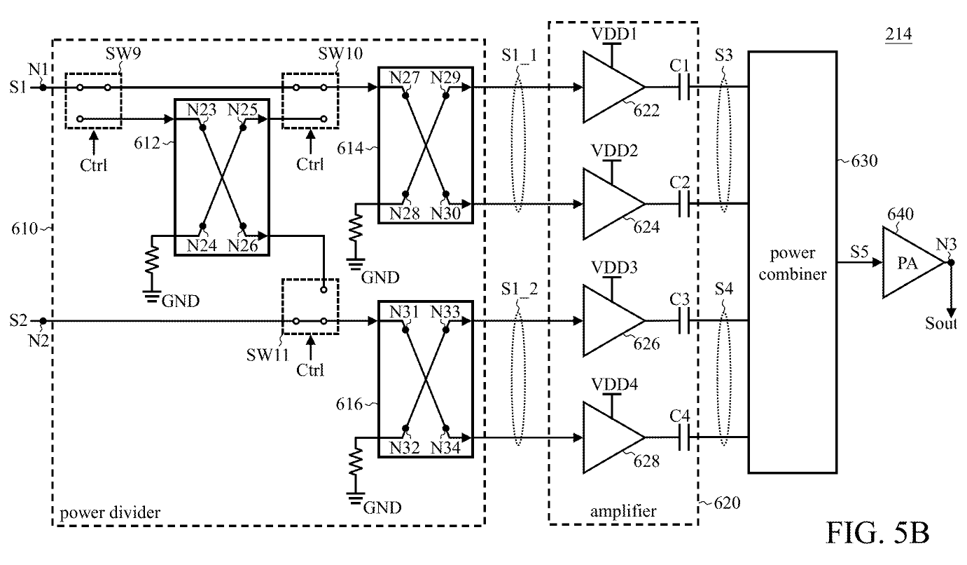

Reference is made to FIGS. 5A-5B, which are circuit diagrams of the multi-input amplifier circuit 214 according to another embodiment of the present invention. The operation scenarios of FIGS. 5A and 5B correspond to FIGS. 2A and 2B, respectively.

The multi-input amplifier circuit 214 includes a power divider 610, an amplifier 620, a power combiner 630, and a PA 640.

The power divider 610 includes a coupler 612, a coupler 614, a coupler 616, a switch SW9, a switch SW10, and a switch SW11. The switches SW9 to SW11 are single-pole double-throw switches.

The first terminal of the switch SW9 is coupled or electrically connected to the input terminal N1 to receive the signal S1; the second terminal of the switch SW9 is coupled or electrically connected to the switch SW10; the third terminal of the switch SW9 is coupled or electrically connected to the input terminal N23 of the coupler 612.

The first terminal of the switch SW10 is coupled or electrically connected to the switch SW9; the second terminal of the switch SW10 is coupled or electrically connected to an input terminal N27 of the coupler 614; the third terminal of the switch SW10 is coupled or electrically connected to an output terminal N25 of the coupler 612.

The first terminal of the switch SW11 is coupled or electrically connected to the input terminal N2 to receive the signal S2; the second terminal of the switch SW11 is coupled or electrically connected to an output terminal N26 of the coupler 612; the third terminal of the switch SW11 is coupled or electrically connected to an input terminal N31 of the coupler 616.

The input terminal N23 of the coupler 612 is coupled or electrically connected to the switch SW9; the input terminal N24 of the coupler 612 is coupled or electrically connected to the reference voltage GND; the output terminal N25 of the coupler 612 is coupled or electrically connected to the switch SW10; the output terminal N26 of the coupler 612 is coupled or electrically connected to the switch SW11.

The input terminal N27 of the coupler 614 is coupled or electrically connected to the switch SW10; an input terminal N28 of the coupler 614 is coupled or electrically connected to the reference voltage GND; an output terminal N29 of the coupler 614 is coupled or electrically connected to a driver amplifier 622; an output terminal N30 of the coupler 614 is coupled or electrically connected to a driver amplifier 624.

The input terminal N31 of the coupler 616 is coupled or electrically connected to the switch SW11; an input terminal N32 of the coupler 616 is coupled or electrically connected to the reference voltage GND; an output terminal N33 of the coupler 616 is coupled or electrically connected to a driver amplifier 626; an output terminal N34 of the coupler 616 is coupled or electrically connected to a driver amplifier 628.

The coupler 614 outputs the intermediate signal S1_1. The coupler 616 outputs the intermediate signal S1_2.

The amplifier 620 includes the driver amplifiers 622 to 628 and capacitors C1 to C4. The capacitor C1 is coupled between the output terminal of the driver amplifier 622 and the power combiner 630. The capacitor C2 is coupled between the output terminal of the driver amplifier 624 and the power combiner 630. The capacitor C3 is coupled between the output terminal of the driver amplifier 626 and the power combiner 630. The capacitor C4 is coupled between the output terminal of the driver amplifier 628 and the power combiner 630.

The driver amplifiers 622 to 628 respectively receive the power supply voltages VDD1, VDD2, VDD3, and VDD4. The characteristics or output power of the driver amplifiers 622 to 628 can be adjusted respectively by adjusting the power supply voltages VDD1 to VDD4. The larger the power supply voltage is, the larger the power or the gain of the corresponding driver amplifier is.

The driver amplifier 622 and the driver amplifier 624 amplify the intermediate signal S1_1 to generate the signal S3. The driver amplifier 626 and the driver amplifier 628 amplify the intermediate signal S1_2 to generate the signal S4.

In some embodiments, the capacitors C1 to C4 can be omitted to reduce costs.

The power combiner 630 combines the signal S3 and the signal S4 to generate the signal S5. In other words, the power of the signal S5 substantially equals the sum of the power of the signal S3 and the power of the signal S4.

In some embodiments, if the gain of the driver amplifiers 622 to 628 is sufficiently large, then the PA 640 can be omitted. In this case, the amplified signal Sout equals the signal S5.

In the operation scenario of FIG. 5A, the switch SW9 connects the input terminal N23 of the coupler 612 to the input terminal N1, the switch SW10 connects the input terminal N27 of the coupler 614 to the output terminal N25 of the coupler 612, and the switch SW11 connects the input terminal N31 of the coupler 616 to the output terminal N26 of the coupler 612. Therefore, the power divider 610 generates the intermediate signal S1_1 and the intermediate signal S1_2 based on the signal S1. The sum of the power of the intermediate signal S1_1 and the power of the intermediate signal S1_2 substantially equal the power of the signal S1. In other words, the signal S5 is equivalent to the result of the signal S1 being amplified by the amplifier 620. In some embodiments, the power of the intermediate signal S1_1 and the power of the intermediate signal S1_2 may be 1:1.

In some embodiments, the couplers 612 to 616 can each be embodied by a Lange coupler or a branch-line coupler. The advantages of the Lange coupler and the branch-line coupler are that they have a stable impedance. The operating principle of the Lange coupler and the branch-line coupler is well known to people having ordinary skill in the art, so further elaboration is omitted for brevity.

In the operation scenario of FIG. 5B, the switch SW9 and the switch SW10 connect the input terminal N27 of the coupler 614 to the input terminal N1, and the switch SW11 connects the input terminal N31 of the coupler 616 to the input terminal N2. Therefore, the coupler 612 is inactive, the power of the intermediate signal S1_1 is substantially equal to the power of the signal S1, and the power of the intermediate signal S1_2 is substantially equal to the power of the signal S2. In other words, the signal S5 is equivalent to the result of the signal S1 and the signal S2 being amplified by the amplifier 620.

In summary, the multi-input amplifier circuit 214 of the present invention can operate in either a single-input mode (FIGS. 2A, 3A, 4A, and 5A) or a multi-input mode (FIGS. 2B, 3B, 4B, and 5B). In the multi-input mode, the amplifier circuit in the transceiver circuit 220 (i.e., the driver amplifier 124 and/or the PA 125) can be turned off to save power. Therefore, the electronic device 200 of the present invention can balance bandwidth and power consumption.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device, comprising:
a first baseband circuit;
a second baseband circuit;
a first transceiver circuit coupled to the first baseband circuit and comprising:
a first transmission circuit coupled to the first baseband circuit; and
a multi-input amplifier circuit coupled to the first transmission circuit;
a second transceiver circuit coupled to the second baseband circuit and comprising:
a second transmission circuit coupled to the second baseband circuit; and
a driver amplifier; and
a switch coupled to the second transmission circuit, the multi-input amplifier circuit, and the driver amplifier;
wherein the switch is controlled by the first baseband circuit or the second baseband circuit and is configured to connect the second transmission circuit to the multi-input amplifier circuit or the driver amplifier.

2. The electronic device of claim 1, wherein the multi-input amplifier circuit has a first input terminal and a second input terminal, the first input terminal is coupled to the first transmission circuit, the second input terminal is coupled to the switch, and the multi-input amplifier circuit comprises:
a power divider coupled to the first input terminal;
an amplifier coupled to the power divider and configured to generate a first signal and a second signal; and
a power combiner coupled to the amplifier and configured to combine the first signal and the second signal to generate a third signal.

3. The electronic device of claim 2, wherein the first transmission circuit outputs a fourth signal, and when the switch connects the second transmission circuit to the driver amplifier, the power divider generates a first intermediate signal and a second intermediate signal according to the fourth signal, and the amplifier amplifies the first intermediate signal and the second intermediate signal to respectively generate the first signal and the second signal.

4. The electronic device of claim 3, wherein the driver amplifier is a first driver amplifier, and the amplifier comprises:
a second driver amplifier configured to amplify the first intermediate signal to generate the first signal; and
a third driver amplifier configured to amplify the second intermediate signal to generate the second signal.

5. The electronic device of claim 3, wherein the power divider comprises:
a first primary coil having a first terminal and a second terminal, wherein the first terminal is coupled to the first input terminal;
a first secondary coil coupled to the amplifier;
a second primary coil having a third terminal and a fourth terminal, wherein the third terminal is coupled to the second terminal, and the fourth terminal is coupled to a reference voltage; and
a second secondary coil coupled to the amplifier.

6. The electronic device of claim 3, wherein the multi-input amplifier circuit has an output terminal, and the power combiner comprises:
a first primary coil coupled to the amplifier;
a first secondary coil having a first terminal and a second terminal, wherein the first terminal is coupled to the output terminal;
a second primary coil coupled to the amplifier; and
a second secondary coil having a third terminal and a fourth terminal, wherein the third terminal is coupled to the second terminal, and the fourth terminal is coupled to a reference voltage.

7. The electronic device of claim 3, wherein the power divider comprises:
a first coupler having a third input terminal, a fourth input terminal, a first output terminal, and a second output terminal, wherein the third input terminal is coupled to the first input terminal, and the fourth input terminal is coupled to a reference voltage;
a second coupler having a fifth input terminal, a sixth input terminal, a third output terminal, and a fourth output terminal, wherein the fifth input terminal is coupled to the first output terminal, the sixth input terminal is coupled to the reference voltage, and the third output terminal and the fourth output terminal are coupled to the amplifier; and
a third coupler having a seventh input terminal, an eighth input terminal, a fifth output terminal, and a sixth output terminal, wherein the seventh input terminal is coupled to the second output terminal, the eighth input terminal is coupled to the reference voltage, and the fifth output terminal and the sixth output terminal are coupled to the amplifier.

8. The electronic device of claim 3, wherein a sum of the power of the first intermediate signal and the power of the second intermediate signal is substantially equal to the power of the fourth signal.

9. The electronic device of claim 2, wherein the first transmission circuit outputs a fourth signal, the second transmission circuit outputs a fifth signal, and when the switch connects the second transmission circuit to the multi-input amplifier circuit, the amplifier amplifies the fourth signal and the fifth signal to respectively generate the first signal and the second signal.

10. The electronic device of claim 9, wherein the driver amplifier is a first driver amplifier, and the amplifier comprises:
a second driver amplifier configured to amplify the fourth signal to generate the first signal; and
a third driver amplifier configured to amplify the fifth signal to generate the second signal.

11. The electronic device of claim 9, wherein the power divider comprises:
a first primary coil having a first terminal and a second terminal, wherein the first terminal is coupled to the first input terminal, and the second terminal is coupled to a reference voltage;
a first secondary coil coupled to the amplifier;
a second primary coil having a third terminal and a fourth terminal, wherein the third terminal is coupled to the second input terminal, and the fourth terminal is coupled to the reference voltage; and
a second secondary coil coupled to the amplifier.

12. The electronic device of claim 9, wherein the multi-input amplifier circuit has an output terminal, and the power combiner comprises:
a first primary coil coupled to the amplifier;
a first secondary coil having a first terminal and a second terminal, wherein the first terminal is coupled to the output terminal;
a second primary coil coupled to the amplifier; and
a second secondary coil having a third terminal and a fourth terminal, wherein the third terminal is coupled to the second terminal, and the fourth terminal is coupled to a reference voltage.

13. The electronic device of claim 9, wherein the power divider comprises:
a first coupler having a third input terminal, a fourth input terminal, a first output terminal, and a second output terminal, wherein the third input terminal is coupled to the first input terminal, the fourth input terminal is coupled to a reference voltage, and the first output terminal and the second output terminal are coupled to the amplifier; and
a second coupler having a fifth input terminal, a sixth input terminal, a third output terminal, and a fourth output terminal, wherein the fifth input terminal is coupled to the second input terminal, the sixth input terminal is coupled to the reference voltage, and the third output terminal and the fourth output terminal are coupled to the amplifier.

14. A multi-input amplifier circuit having a first input terminal, a second input terminal, and an output terminal, the first input terminal used for receiving a first signal, and the second input terminal used for receiving a second signal, the multi-input amplifier circuit comprising:
a power divider comprising a first primary coil, a first secondary coil, a second primary coil, and a second secondary coil and configured to generate a first intermediate signal and a second intermediate signal, wherein the first primary coil is coupled to the first input terminal, and the second primary coil is coupled to a reference voltage;
a first switch coupled to the first primary coil and the second primary coil;
a second switch coupled to the second input terminal and the second primary coil;
an amplifier coupled to the first secondary coil and the second secondary coil and configured to amplify the first intermediate signal and the second intermediate signal to respectively generate a third signal and a fourth signal; and
a power combiner coupled to the amplifier and the output terminal, and configured to combine the third signal and the fourth signal to generate a fifth signal.

15. The multi-input amplifier circuit of claim 14, wherein when the first switch connects the first primary coil to the first secondary coil and the second switch does not connect the second primary coil to the second input terminal, a sum of the power of the first intermediate signal and the power of the second intermediate signal is substantially equal to the power of the first signal.

16. The multi-input amplifier circuit of claim 14, wherein when the first switch does not connect the first primary coil to the first secondary coil and the second switch connects the second primary coil to the second input terminal, the first intermediate signal is substantially equal to the first signal, and the second intermediate signal is substantially equal to the second signal.

17. A multi-input amplifier circuit having a first input terminal, a second input terminal, and an output terminal, the first input terminal used for receiving a first signal, and the second input terminal used for receiving a second signal, the multi-input amplifier circuit comprising:
a power divider coupled to the first input terminal and the second input terminal, configured to generate a first intermediate signal and a second intermediate signal, and comprising a first coupler, a second coupler, and a third coupler that are mutually coupled;
an amplifier coupled to the power divider and configured to amplify the first intermediate signal and the second intermediate signal to respectively generate a third signal and a fourth signal; and
a power combiner coupled to the amplifier and the output terminal, and configured to combine the third signal and the fourth signal to generate a fifth signal.

18. The multi-input amplifier circuit of claim 17, wherein the output terminal is a first output terminal, and the power divider further comprises:
a first switch coupled to the first input terminal and a third input terminal of the first coupler;
a second switch coupled to the first switch, a second output terminal of the first coupler, and a fourth input terminal of the second coupler; and
a third switch coupled to the second input terminal, a third output terminal of the first coupler, and a fifth input terminal of the third coupler.

19. The multi-input amplifier circuit of claim 18, wherein when the first switch connects the first input terminal to the third input terminal of the first coupler, the second switch connects the second output terminal of the first coupler to the fourth input terminal of the second coupler, and the third switch connects the third output terminal of the first coupler to the fifth input terminal of the third coupler, a sum of the power of the first intermediate signal and the power of the second intermediate signal substantially equals the power of the first signal.

20. The multi-input amplifier circuit of claim 18, wherein when the first switch and the second switch connect the first input terminal to the fourth input terminal of the second coupler, and the third switch connects the second input terminal to the fifth input terminal of the third coupler, the first intermediate signal is substantially equal to the first signal, and the second intermediate signal is substantially equal to the second signal.
